(19) United States
(12) Patent Application Publication
(10) Pub. No.: US 2024/0416870 A1
(43) Pub. Date: Dec. 19, 2024

(54) WIPER BLADE AND WIPER DEVICE

(71) Applicant: CAP CORPORATION, Sangju-si (KR)

(72) Inventor: Young Hun LIM, Sangju-si (KR)

(73) Assignee: CAP CORPORATION, Sangju-si (KR)

(21) Appl. No.: 18/743,622

(22) Filed: Jun. 14, 2024

(30) Foreign Application Priority Data
Jun. 16, 2023 (KR) 10-2023-0077666

(51) Int. Cl. B60S 1/34; B60S 1/38

(52) U.S. Cl. CPC B60S 1/3415; B60S 1/3806; B60S 1/3849; B60S 2001/3812

(57) ABSTRACT

A wiper blade includes: a contact member having a relatively high length-to-width ratio and sliding along a surface of a contact target while maintaining direct contact with the surface; and a cover member provided across the contact member from the contact target. The cover member includes a connecting portion connected to the contact member and an exposed portion provided on top of the connecting portion. The exposed portion includes a plurality of support members longitudinally disposed at intervals and a finishing member longitudinally connecting the tops of the support members, thereby forming an open-frame structure.

### CROSS-REFERENCE TO RELATED APPLICATION

The present application claims priority to Korean Patent Application No. 10-2023-0077666, filed Jun. 16, 2023, the entire contents of which is incorporated herein for all purposes by this reference.

### BACKGROUND

The present invention relates to a wiper blade and wiper device.

A wiper device is generally installed in a vehicle to wipe the surface of the windshield. The wiper device comprises a wiper motor, a wiper arm, a wiper blade, and the like, and an adapter may be used for structural connection between the wiper arm and the wiper blade.

The wiper arm is connected to the pivoting shaft of the wiper motor at its base to be driven by the wiper motor to pivot in a reciprocating manner. Depending on the windshield size, one or more wiper arms are provided. When a plurality of wiper arms are provided, the wiper arms are provided such that their reciprocations do not interfere with each other.

In addition, the wiper blade is detachably coupled to the end of the wiper arm through the adapter. The wiper blade has a straight-line shape and slides across the surface of the windshield to clean the surface, driven by the movement of the pivoting wiper arm while maintaining direct contact with the windshield.

The wiper blades are generally used to wipe away raindrops falling on the windshield during rainy weather to ensure clear visibility for the driver. However, when a part of the wiper blade that is in contact with the windshield moves in one direction to clean the windshield and then returns, the part in contact with the windshield drags the rainwater back to blur the windshield.

This phenomenon, referred to as the water drag by the wiper, significantly reduces the driver's visibility and acts as a hindrance to safe driving. In particular, nighttime driving in rain may be especially hazardous due to the water drag phenomenon.

### SUMMARY

The present invention is intended to address the issue in the related art as described above. An object of the present invention is to provide a wiper blade and a wiper device having a cover member structured to be penetrated in the width direction to suppress water drag caused by the airflow passing over the cover member.

A wiper blade according to an aspect of the present invention comprises a contact member having a relatively high length-to-width ratio and sliding along the surface of a contact target while maintaining direct contact with the surface; and a cover member provided across the contact member from the contact target, wherein the cover member comprises a connecting portion connected to the contact member and an exposed portion provided on top of the connecting portion, and the exposed portion comprises a plurality of support members longitudinally disposed at intervals and a finishing member longitudinally connecting the tops of the support members, thereby forming an open-frame structure.

Specifically, the exposed portion may have a lateral cross-section in a tapering shape that widens downwards.

Specifically the exposed portion may have a lateral flow path for a fluid to pass through between the support members longitudinally disposed at intervals.

Specifically, the support member may include a plurality of first support members inclining in a first length direction from the bottom to the top, and the flow path may be configured as a parallelogram.

Specifically, the support member may further include a plurality of second support members inclining in a second length direction, opposite the first length direction, from the bottom to the top.

Specifically, the first support member and the second support member may intersect at a predetermined point in the height direction.

Specifically, the second support member may have a smaller width than the first support member.

Specifically, the flow path may be provided at least on the lower side, among the lower and upper sides with respect to the intersection point between the first support member and the second support member, to allow fluid flow.

Specifically, the second support member may be provided with a curved member extending in the first length direction from the intersection point with the first support member.

Specifically, the contact member may be concave towards the surface of the contact target when not in direct contact with the contact target and deform to conform to the surface of the contact target when in direct contact with the contact target, while the cover member has an open-frame structure so that interference against the deformation of the contact member may be reduced.

Specifically, the cover member may be provided with a flow path larger at the longitudinal center portion than at either end along its length.

Specifically, the flow path in the cover member may gradually increase in size as the longitudinal center portion is approached from either end along its length.

Specifically, the plurality of support members may incline in the first length direction from the bottom to the top to form a parallelogram-shaped flow path, and the exposed portion may further include an interference member provided in the flow path to interfere with the fluid passing through the flow path.

Specifically, the interference member may have a smaller width than the support member and may incline in the second length direction opposite the first length direction from the bottom to the top.

A wiper blade according to an aspect of the present invention comprises a contact member having a relatively high length-to-width ratio and sliding along the surface of a contact target while maintaining direct contact with the surface; and a cover member provided across the contact member from the contact target, wherein the cover member comprises a connecting portion connected to the contact member and an exposed portion provided on top of the connecting portion, and the exposed portion has a lateral cross-section in a tapering shape that widens downwards to impede fluid flow in the width direction on the contact target and generate a negative pressure on one side but has an open-frame structure at least along its width to guide the fluid flow from the other side to the one side and increase the pressure on the one side.

The wiper device according to an aspect of the present invention includes a wiper blade and an adapter provided at one point on the wiper blade to be coupled to the wiper arm.

### BRIEF DESCRIPTION OF THE DRAWINGS

FIG. 1 is a perspective view of a wiper device according to a first embodiment of the present invention.

FIG. 2 is a partial side view of a wiper device according to a first embodiment of the present invention.

FIG. 3 is a partial side view of a wiper device according to a first embodiment of the present invention.

FIG. 4 is a partial plan view of a wiper device according to a first embodiment of the present invention.

FIG. 5 is a partial perspective view of a wiper device according to a first embodiment of the present invention.

FIG. 6 is a partial perspective view of a wiper device according to a first embodiment of the present invention.

FIG. 7 is a partial perspective view of a wiper device according to a first embodiment of the present invention.

FIG. 8 is a partial perspective view of a wiper device according to a first embodiment of the present invention.

FIG. 9 is a cross-sectional view of a wiper device according to a first embodiment of the present invention.

FIG. 10 is a cross-sectional view of a wiper device according to a first embodiment of the present invention.

FIG. 11 is a view describing the water drag of a wiper device.

FIG. 12 is a view showing the experiment results of water drag of a wiper device according to a comparative example and the present invention.

### DETAILED DESCRIPTION

An object, specific advantages, and novel features of the present invention will be made clearer from the following description and preferred embodiments associated with the accompanying drawings. It is to be noted that in assigning reference numerals to the components in each drawing in this specification, the same components are intended to have the same numeral as much as possible even when they are shown in different drawings. In addition, when it is determined that the specific description of widely-known related technology obscures the gist of the present invention inadvertently, the detailed description thereof will be omitted in the description of the present invention.

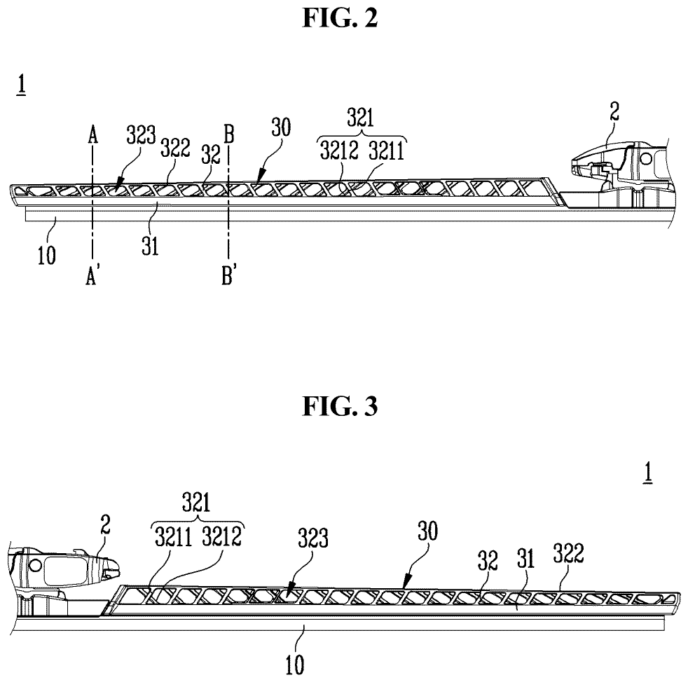

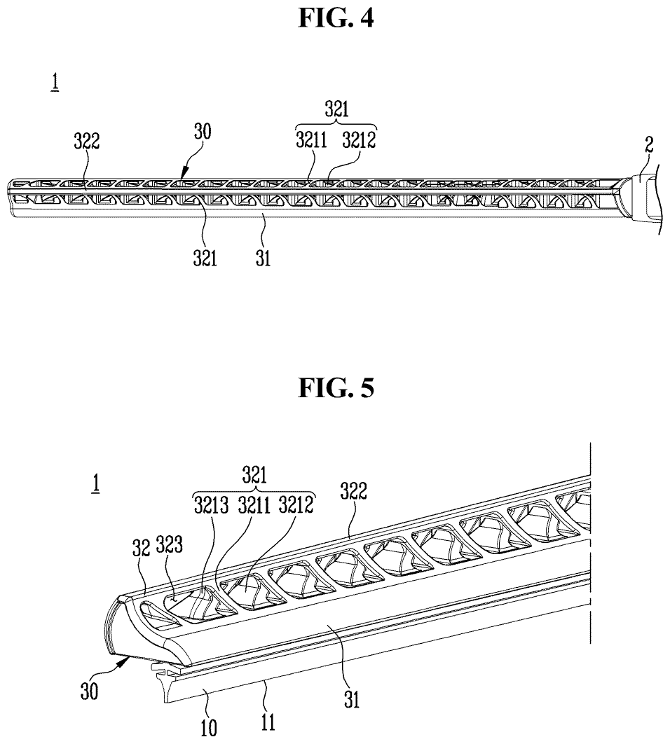

In this specification, the length direction refers to the direction in which the wiper blade is elongated, which may mean the right-left direction in FIG. 4. In addition, the width direction is the direction orthogonal to the length direction, which may mean the up-down direction in FIG. 4. In addition, the height direction may refer to the direction away from the contact target with which the wiper blade makes direct contact, which may mean the up-down direction in FIG. 2. It is to be noted that the directionality is only for convenience in describing the present invention and does not limit the scope of rights of the present invention.

In addition, movements or motions described herein are relative and the positions of components other than the moving components are not to be construed as fixed. Further, expressions such as connecting, engaging, interlocking, fixing, and the like encompass direct interactions between two components as well as indirect interactions with other components disposed in between.

The wiper blade and wiper device according to the present invention will be described with reference to the diagrams in the following

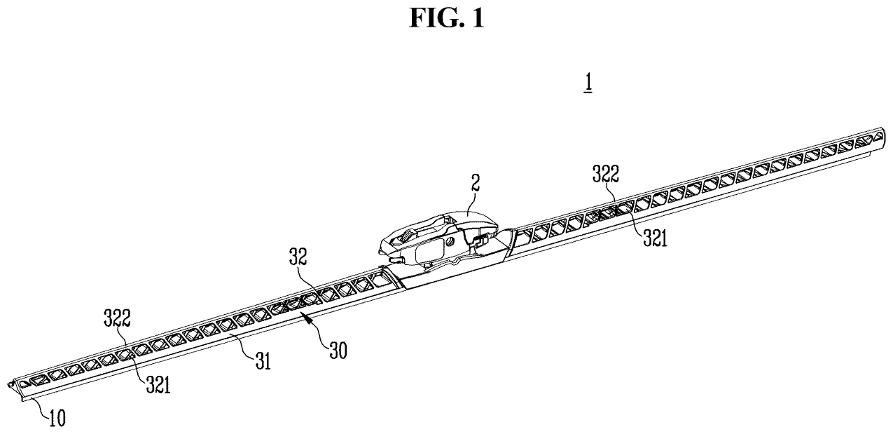

FIG. 1 is a perspective view of a wiper device according to a first embodiment of the present invention; FIG. 2 is a side view of a wiper device according to a first embodiment of the present invention; FIG. 3 is a side view of a wiper device according to a first embodiment of the present invention; FIG. 4 is a partial plan view of a wiper device according to a first embodiment of the present invention.

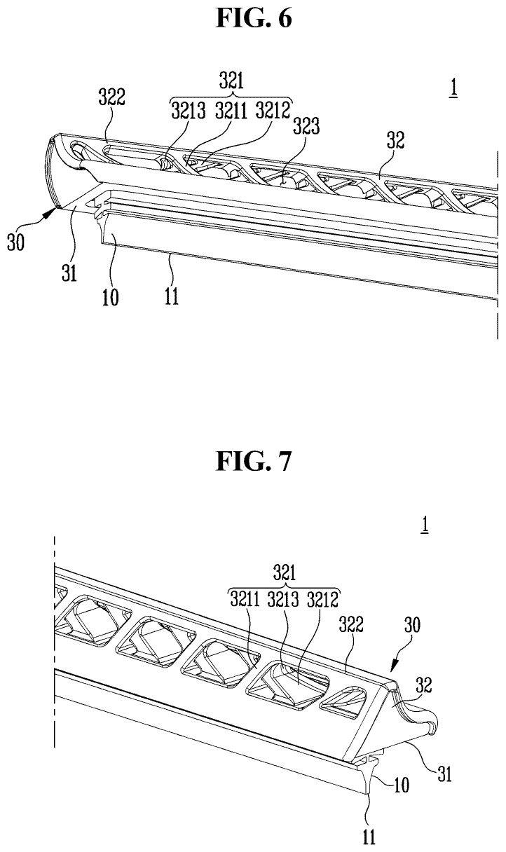

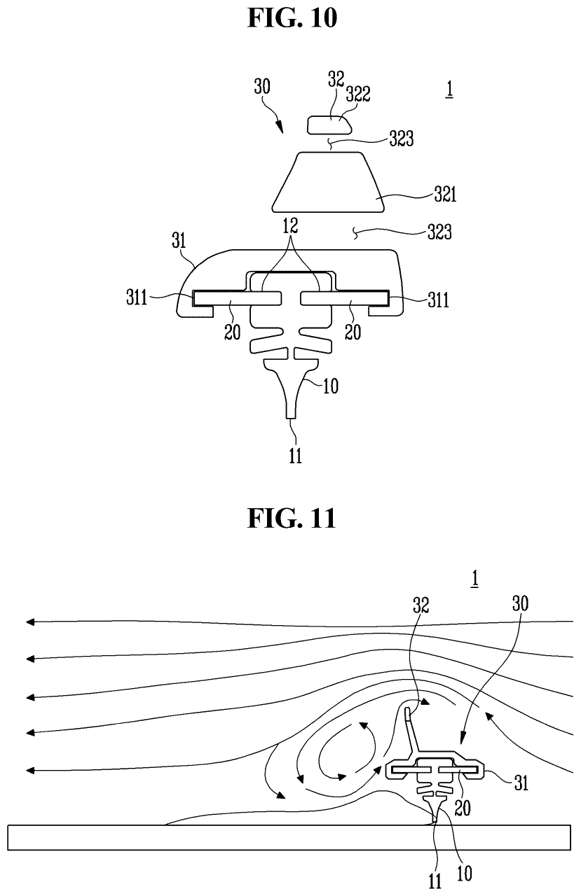

FIGS. 5 to 8 are partial perspective views of a wiper device according to a first embodiment of the present invention and FIGS. 9 and 10 are cross-sectional views of a wiper device according to a first embodiment of the present invention. FIG. 9 is a cross-sectional view taken along A-A′ in FIG. 2, and FIG. 10 is a cross-sectional view taken along B-B′ in FIG. 2.

FIGS. 1 to 10 show that a wiper device according to the first embodiment of the present invention may include a wiper blade 1 and an adapter 2. The wiper device of the present invention may include the wiper blade 1 and the adapter 2 described below and may further include a wiper arm.

It is to be noted that the wiper arm pivots around its base and is connected to the wiper blade 1 at its end. The adapter 2 may be utilized to connect the wiper arm with the wiper blade 1. The wiper arm delivers pivoting force to the wiper blade 1 to realize the cleaning of a contact target by the wiper blade 1.

Here, the contact target may be the windshield of a vehicle but is not limited thereto. Any object that can be cleaned by sliding may be the contact target.

The wiper arm is directly or indirectly connected to a driving source (motor, etc.) provided in a vehicle or the like so that its end pivots in an arc, driven by the rotational force of the driving source. At this time, the wiper blade 1 is connected to the end of the wiper arm so that the wiper blade 1 may realize cleaning while moving in a predetermined path in direct contact with the contact target.

The wiper arm may have a variety of unlimited shapes, and the shape of the adapter 2 may be freely modified to conform to the shape of the wiper arm. The adapter 2 may be configured as a multi-fastening type to which a plurality of wiper arms having different shapes may be selectively coupled

The wiper blade 1 cleans the surface of the contact target while moving in direct contact with the contact target. At this time, the contact target may be any object that can be cleaned by sliding on the windshield of a vehicle and the like, as described above. The wiper blade 1 includes a contact member 10, an elastic member 20, and a cover member 30.

The contact member 10 has a relatively high length-to-width ratio and slides along the surface of the contact target while maintaining direct contact with the surface. The contact member 10 has a cross-sectional structure allowing direct contact with the surface as well as appropriate friction against the surface to facilitate smooth sliding for cleaning. For example, the contact member 10 may have a V-shaped cross-section extending in the length direction, as illustrated in FIG. 9 and the like.

The contact member 10 may be configured to minimize the contact area with the contact target. In addition, the contact member 10 may be made of a material such as rubber that has a cushioning capacity for direct contact with the surface. Hereinafter, the side of the contact member 10 that comes into direct contact with the contact target is referred to as a contact edge 11.

When no external force is applied, the contact edge 11 of the contact member 10 may be in a shape different from the surface of the contact target. In other words, the contact member 10 may be concave towards the surface of the contact target when not in direct contact with the contact target.

However, once the wiper blade 1 is coupled to the wiper arm through the adapter 2 to come into direct contact with the contact target, the contact member 10 is deformed to conform to the surface of the contact target. At this time, the contact member 10 may be deformed in the direction of resisting the elastic force of the elastic member 20 to maintain an appropriate contacting pressure by the continuous application of the elastic force from the elastic member 20.

The contact member 10 may engage with the elastic member 20. As illustrated in FIG. 9, the contact member 10 is provided with a contact edge 11 at the bottom and a groove 12 in the width direction at the top. At least a part of the elastic member 20 is seated in the groove 12. In other words, the contact member 10 is in direct contact with the contact target at the bottom and engages with the elastic member 20 at the top to be subject to an elastic force. In addition, the contact member 10 may be directly or indirectly connected at the top to the cover member 30 to be described below.

The contact member 10 and the elastic member 20 may not securely engage with each other by their mutual coupling alone. The elastic member 20 may be secured between the contact member 10 and the cover member 30, with an inner side seated in the contact member 10 and the outer side surrounded by the cover member 30 to be described below.

The elastic member 20 applies an elastic force to the contact member 10. The elastic member 20 may be made of a material (metal, etc.) stiffer than the contact member 10 or the cover member 30 to be described below and may be configured to maintain the elongated shape of the wiper blade 1.

For example, the elastic member 20 may be configured in the shape of a leaf spring, but the structure or material may be varied as long as the contact member maintains direct contact with the contact target as a whole.

The elastic member 20 may be provided in a pair and may be provided on either side of the contact member 10 in the width direction. To this end, the contact member 10 may be provided with grooves 12 for the insertion of the elastic member 20 on either side, as illustrated in FIG. 9.

The elastic member 20 imparts to the contact member 10 an elastic force to return to a more curved shape than the contact target. Therefore, when the contact member 10 is pressed against the contact target by the wiper arm, the contact edge 11 of the contact member 10 is pressed by the wiper arm to deform into a shape conforming to the surface of the contact target but earns the force to push the contact target by the elastic force of the elastic member 20. This allows the contact member 10 to be securely in direct contact with the contact target.

The cover member 30 is provided across the contact member 10 from the contact target.

The cover member 30 may close the connection between the contact member 10 and the elastic member 20 to ensure an aesthetic appearance while preventing separation of the elastic member 20.

The upper portion and the lower portion of the cover member 30 in the height direction may be referred to as a connecting portion 31 and an exposed portion 32 respectively. The connecting portion 31 is connected to the contact member 10, and the exposed portion 32 is provided on top of the connecting portion 31. The connecting portion 31 and the exposed portion 32 may be separately made to be subsequently assembled together or may be integrally made without structural separation.

The connecting portion 31 of the cover member 30 has a C-shaped structure surrounding the elastic member 20 inserted into the groove 12 of the contact member 10 on either side in the width direction. The cover member 30, like the contact member 10, may also be provided with a groove 311 for the insertion of the elastic member 20, and the groove 311 of the cover member 30 may be provided opposite the groove 12 of the contact member 10. At this time, the inner end of the elastic member 20 is inserted into the groove 12 of the contact member 10 and the outer end is inserted into the groove 311 of the cover member 30 so that the elastic member 20 is fixedly positioned between the contact member 10 and the cover member 30. This allows the inner side of the elastic member 20 in the width direction to be surrounded by the contact member 10 and the outer side to be surrounded by the cover member 30.

In other words, the cover member 30 and the contact member 10 may be coupled to each other with the elastic member 20 disposed in between. The cover member 30 and the contact member 10 may structurally engage with each other to be secured, and other physical and chemical engaging methods may be utilized in various manners. In addition, various non-limiting securing structures other than the method described above may be utilized.

The connecting portion 31, which is the bottom of the cover member 30, may surround the elastic member 20 connected to the contact member 10 as described above. In contrast, the exposed portion 32, which is the top of the cover member 30, may be a part exposed to the outside when the wiper blade 1 is placed on the contact target.

At this time, the exposed portion 32 may have a structure designed to disperse the wind and avoid wind resistance to prevent the wiper blade 1 from being moved or lifted by the wind while the vehicle is driving.

The exposed portion 32 may have a lateral cross-section in a tapering shape that widens downwards. For example, the exposed portion 32 may have an A-shaped or mountain-shaped cross-section extending in the length direction. Alternatively, the exposed portion 32 may have a symmetrical or asymmetrical pointed cross-section that tapers towards the top, like a wave, and extends in the length direction.

Of course, since the contact member 10 may be secured at a specific position on the contact target by the wiper arm or the like, the exposed portion 32, which is the top of the cover member 30, may be designed in various shapes beyond those previously mentioned, taking into accounts factors such as wind resistance, aesthetic appearance. In particular, the exposed portion 32 has an open-frame structure in the present invention. This will be described below.

The cover member 30 may be made of a material having a higher stiffness than the contact member 10, and the elastic member 20 is accommodated between the cover member 30 and the contact member 10 so that the elastic member 20 made of metal or the like is surrounded by the cover member 30 and the contact member 10, and thus contact with moisture is prevented. Therefore, rusting of the metal elastic member 20 may be suppressed.

A pair of cover members 30 may be separately provided along its length. This is to ensure that the adapter 2, to be described below, engages the longitudinal center portion of the wiper blade 1.

In other words, each of the pair of cover members 30 may be provided on either side of the adapter 2 along its length. However, the adapter 2 is provided to partially overlap the pair of cover members 30 at least so that the gap between the cover member 30 and the adapter 2 may be minimized. For example, the cover member 30 is provided only with the connecting portion 31 without the exposed portion 32 in the part where the adapter 2 is provided so that the connecting portion 31 is continuously provided in the length direction of the wiper blade 1 even though there is no exposed portion 32 on either side of the adapter 2. Therefore, exposure of the elastic member 20 may be prevented.

The exposed portion 32 may have a support member 321 and a finishing member 322. A plurality of support member 321 is longitudinally disposed at intervals. The support member 321 extends upwards from the top of the connecting portion 31 by a predetermined height and may incline at a predetermined angle in the length direction.

The plurality of support members 321 may incline at the same angle. In other words, all the support members 321 may be parallel to each other. The support members 321 are longitudinally disposed at intervals, and fluid movement in the width direction is allowed in the space between at least two support members 321.

The finishing member 322 longitudinally connects the tops of the support members 321. The finishing member 322 and the support member 321 may be assembled together or may be integrally manufactured. The finishing member 322 and the support member 321 may be connected without forming a step difference. In other words, viewed from the lateral cross-section, the support member 321 and the finishing member 322 may be continuously connected.

At least two or more support members 321 extend upward from the top of the connecting portion 31 and the finishing member 322 connects the plurality of support members 321 so that a lateral passage is formed by the top of the connecting portion 31, support member 321, and the finishing member 322. At this time, the passage may have a closed cross section and guides the fluid flow in the width direction.

In other words, longitudinally disposing a plurality of support members 321 at intervals on the connecting portion 31 and providing at least one finishing member 322 connecting all the tops of the plurality of support members 321 in the exposed portion 32 allow the exposed portion 32 to have an open-frame structure at least along its width. Therefore, the exposed portion 32 has a lateral flow path 323 for fluid to pass through between the support members 321 longitudinally disposed at intervals. This causes the fluid flowing in the width direction of the wiper blade 1 to pass through the cover member 30 so that the water drag phenomenon is suppressed. This will be described in detail below.

In addition, the exposed portion 32 forms a flow path 323 in a closed cross section formed by the support member 321, finishing member 322, and the like so that the fluid passing through the flow path 323 may be accelerated. This allows the exposed portion 32 to deliver the accelerated fluid to quickly resolve a pressure difference when the pressure difference occurs between one side and the other side in the width direction. This will be described in detail with reference to FIG. 11 and the like.

The flow path 323 may be densely provided between either end of the cover member 30 in the length direction to effectively suppress water drag over the entire length of the wiper blade 1. In other words, the cover member 30 has an open-frame structure so that the flow paths 323 may be uniformly disposed throughout rather than partially disposed in a part of the longitudinal center portion or a part of either end.

In addition, the cover member 30 may have lateral cross-sections of varying areas along its length. For example, the cover member 30 may have lateral cross-sections that increase at least in height, from among the height and width, as the longitudinal center portion is approached from either end along its length. At this time, the flow path 323 may also gradually increase in size (at least the height) as the longitudinal center portion is approached from either end along its length.

The support member 321 provided in the exposed portion 32 may include a first support member 3211 and a second support member 3212. A plurality of first support member 3211 may be provided, inclining in a first length direction from the bottom to the top.

The plurality of first support members 3211 are provided in parallel from the longitudinal center portion to either end along the length of the wiper blade 1. In addition, the first support member 3211 may be symmetrically provided with respect to the wiper blade 1 along its length. In other words, as illustrated in FIG. 2, the plurality of first support members 3211 longitudinally provided on one side of the adapter may incline to the left from the bottom to the top, and the plurality of first support members 3211 provided on the other side of the adapter 2 may incline to the right from the bottom to the top, as illustrated in FIG. 3

The exposed portion 32 has parallelogram-shaped flow paths 323 through the plurality of first support members 3211 inclining in parallel. Of course, the flow paths 323 may also be symmetrically shaped on either side of the adapter 2.

A plurality of second support member 3212 is provided, inclining in a second length direction opposite the first length direction from the bottom to the top. The number of secondary support member 3212 may correspond to the number of the first support member 3211 and/or the number of flow path 323.

The second support member 3212, like the first support member 3211, is also symmetrically provided on either side of the adapter 2 along its length. In other words, as illustrated in FIG. 2, the plurality of second support members 3212 provided on one side of the adapter 2 along its length incline to the right from the bottom to the top, and the plurality of second support members 3212 provided on the other side of the adapter 2 incline to the left from the bottom to the top, as illustrated in FIG. 3.

At least a part of the second support member 3212 may be provided in the flow path 323 surrounded by the first support member 3211 and the finishing member 322. However, a part of the second support member 3212 may be positioned in one flow path 323, and the rest may be positioned in another flow path 323.

In other words, the second support member 3212 intersects the first support portion 3211 at a predetermined point in the height direction. Therefore, the first support member 3211 and the second support member 3212 intersecting each other may form an X shape having an intersection point. Therefore, the exposed portion 32 may form a truss structure through the first support member 3211 and the second support member 3212 inclining in opposite directions, thereby ensuring the durability of the open-frame structure.

The flow paths 323 are provided above and below the intersection point between the first support member 3211 and the second support member 3212 to allow fluid flow.

The exposed portion 32 forms an open-frame structure to allow fluid to pass through in the width direction so that the water drag phenomenon may be suppressed, but as the degree of opening increases, the effect of preventing the lifting of the wiper blade may be reduced. To address this issue, the first support member 3211 and the second support member 3212 form a structure having an intersection point to ensure basic lifting prevention function.

In the exposed portion 32, the first support member 3211 may be provided to form a flow path 323 that guides the fluid's movement in the width direction, while the second support member 3212 may be provided to enhance the durability of the exposed portion 32. In this case, the second support member 3212 may have a smaller width than the first support member 3211, but the configuration is not limited thereto.

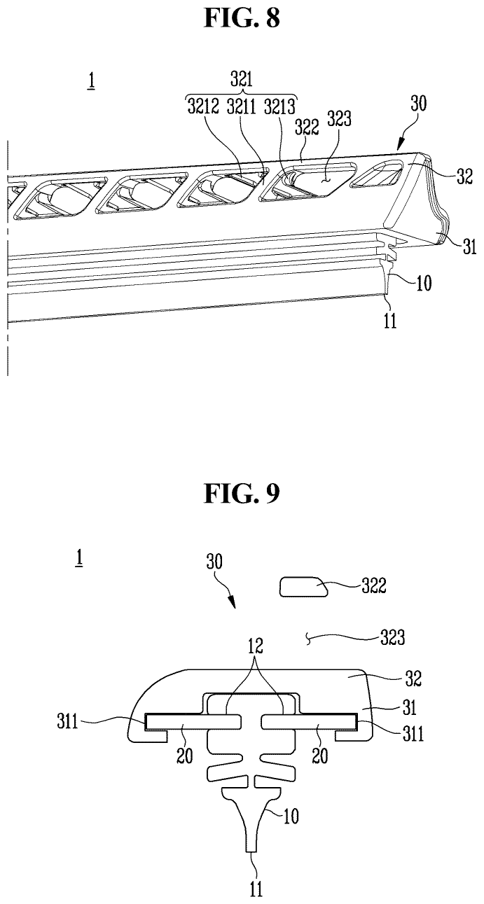

In addition, the second support member 3212 may be provided with a curved member 3213 at the intersection point with the first support member 3211. As illustrated in FIG. 8, the curved member 3213 may extend from the second support member 3212 in the first length direction with respect to the intersection point and may have its durability reinforced through the second support member 3212.

In the cover member 30 having an open-frame structure, a flow path 323 is formed by the support member 321 (the first support member 3211 in particular). At this time, the configuration previously referred to as the second support member 3212 may be defined as an interference member 3212.

In other words, the exposed portion 32 has a plurality of support member 321 longitudinally disposed at intervals and forms an open-frame structure having a parallelogram-shaped flow path 323 by the plurality of support members 321 inclining in the length direction. Furthermore, the exposed portion 32 further includes the interference member 3212 provided in the flow path 323 to interfere with the fluid passing through the flow path 323.

The interference member 3212 has a smaller width than the support member 321 and inclines from the bottom to the top in a second length direction opposite the first length direction in which the support member 321 inclines.

The description of the specific shape of the interference member 3212 may be substituted with the previous description of the second support member 3212. However, in the present embodiment, the interference member 3212 is provided in the flow path 323 so that the fluid passing through the flow path 323 quickly may be regulated.

The adapter 2 is provided at one point of the wiper blade 1 to be coupled to the wiper arm. The adapter 2 may be an intermediate connecting body for connecting the wiper arm and the wiper blade 1 to each other.

As described above, the exposed portion 32 of the cover member 30 has a lateral cross-section having a tapering shape that widens downward to disperse wind. However, the exposed portion 32 may not be provided at least in the longitudinal center portion of the wiper blade 1, and the adapter 2 may be coupled thereto.

The adapter 2 may be designed to be attachable to and detachable from the wiper blade 1 or the wiper arm, but separability is not a requirement. In other words, the adapter 2 may be integrally formed with a part of the wiper blade 1, or at least a part of the adapter 2 may be integrated with the wiper blade 1 and/or the wiper arm.

The adapter 2 may include a base (reference numeral is not shown) fixed to the wiper blade 1 and a body (reference numeral is not shown) rotatably connected to the top of the base in the length direction.

The base may be provided between a pair of exposed portions 32 in the wiper blade 1, or the base may be fixedly installed in the center portion of the wiper blade 1 from which the exposed portion 32 is omitted. The base may be coupled to the elastic member 20 while enclosing the elastic member 20. This configuration allows for the omission of the cover member 30 in the part where the base is installed.

The body is connected to the base through a protrusion structure but is provided to be rotatable in the length direction relative to the base. In addition, the body is structured to allow the wiper arms to be attached and detached.

In other words, the body is connected to the base at the bottom and is connected to the wiper arm at the top so that the wiper blade 1 and the wiper arm may be interconnected. At this time, the body is detachable from the wiper arm so that the user may disengage the body from the wiper arm when the user intends to replace the wiper blade 1.

In addition, as described above, the contact member 10 is concave towards the surface of the contact target when not in direct contact with the contact target and deforms to conform to the surface of the contact target when in direct contact with the contact target. The cover member 30 may assist the contact member 10 in the deformation. In other words, the cover member 30 has the open-frame structure so that the elastic resistance against the deformation of the contact member 10 may be reduced, compared to the conventional case of a closed structure.

The cover member 30 may be made of a stiffer material than the contact member 10. However, even so, the cover member 30 is structured to be easily deformable through the support member 321 and the like. Compared to the conventional case, the present invention allows the contact member 10 to be deformed more effectively to conform to the surface of the contact target.

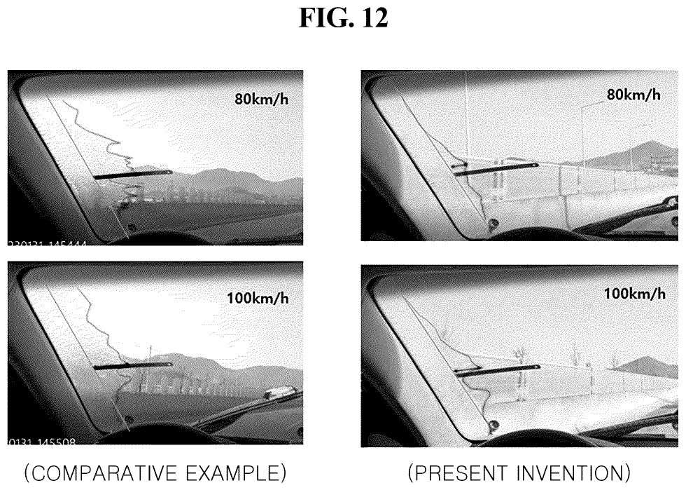

The effectiveness of the present invention in reducing the water drag phenomenon will be described with reference to FIGS. 11 and 12 and the like below.

FIG. 11 is a view describing water drag of a wiper device, and FIG. 12 is a view showing experiment results of the water drag of a wiper device according to a comparative example and the present invention.

FIG. 11 shows that the contact edge 11 of the contact member 10 in the wiper device is in direct contact with the windshield and that the pivoting of the wiper arm moves the contact edge 11 right and left, in relation to FIG. 11.

The cover member 30 across from the contact member 10 has a tapering shape that widens downwards to disperse the wind flowing in the height direction. However, as shown in FIG. 11, when a wind flowing in the width direction of the wiper blade 1 is present, the lateral flowing is impeded by the mountain-shaped cover member 30.

At this time, a positive pressure is generated on the right side of the cover member 30 in FIG. 11 while a negative pressure is generated on the left side in contrast to the right side. As a result, a part of the airflow on the left side of the cover member 30 bends to flow back to the right side, resulting in a backflow. This backflow pushes the water, wiped away by the contact edge 11 when the contact edge 11 moves from the right to the left, to the right when the contact edge 11 moves from the left to the right.

Therefore, at least a part of the water wiped away to the left by the contact edge 11 is dragged back to the right, and this water drag phenomenon obscures a part of the windshield to obstruct the driver's vision and compromise safe driving.

To address this issue, the present invention proposes that the cover member 30 have the exposed portion 32 having an open-frame structure along its length. In other words, the exposed portion 32 has a lateral cross-section in a tapering shape that widens downwards to impede lateral fluid movement on the windshield so that the negative pressure on one side of the exposed portion 32 and the positive pressure on the other side are regulated. Simultaneously, the exposed portion 32 has an open-frame structure along its length so that the exposed portion 32 may guide fluid flow from the other side to one side.

This allows the exposed portion 32 to increase the pressure on one side to eliminate the pressure difference between the negative and positive pressures and significantly reduce the water drag phenomenon caused by the negative pressure. In other words, the open-frame structure of the exposed portion 32 generates a fluid flow from the right to the left in FIG. 11. In particular, this fluid flow passes through the flow path 323 of the exposed portion 32 and may be accelerated by the flow path 323 formed as a closed cross section.

In other words, the flow path 323 is designed in a duct shape to accelerate fluid flow, rapidly transferring fluid flow from the right to the left as shown in FIG. 11. This allows the cover member 30 to alleviate the negative pressure generated on the left side of the exposed portion 32, thereby effectively reducing the water drag phenomenon.

This will be described again with reference to FIG. 12. The left side of FIG. 12 shows a comparative example in which the cover member 30 does not have an open-frame structure so that the fluid cannot pass through the cover member 30 in the width direction, and the right side of FIG. 12 shows the present embodiment in which the cover member 30 has an open-frame structure.

As shown in FIG. 12, water drag was observed while the vehicle was driven at a predetermined speed (80 km/h or 100 km/h) with a ruler attached to the left side of the windshield. The experiment results show that when the vehicle was driven at 80 km/h, water drag up to 97 mm was observed in the comparative example while water drag was substantially reduced to a maximum of 35 mm (a 36% reduction) in the present embodiment.

In addition, when the vehicle was driven at 100 km/h, water drag up to 78 mm was observed in the comparative example while water drag was reduced to a maximum of 55 mm (a 70% reduction) in the present embodiment. In other words, it was confirmed that the present embodiment reduces water drag by at least 30% relative to the comparative example during high-speed driving where securing the driver's vision is crucial.

The present invention has been described in detail through a specific embodiment, but this is intended to describe the present invention specifically, and the invention is not limited to the embodiment. It will be apparent that modifications or improvements may be made by those skilled in the art within the scope of the technical spirit of the present invention.

Simple modifications and alterations of the present invention all fall within the scope of the present invention, and the specific scope of protection of the present invention will be made clear by the attached patent claims.

The wiper blade and wiper device according to the present invention include a cover member structured with a plurality of support longitudinally disposed at intervals to allow the airflow to pass in the width direction of the wiper blade, thereby minimizing the water drag phenomenon to ensure safe driving.

In addition, the wiper blade and wiper device according to the present invention includes a cover member in an open-frame structure to allow a more flexible longitudinal elastic deformation of the contact member, thereby improving the adhesion performance to the windshield.

1. A wiper blade comprising:
a contact member having a relatively high length-to-width ratio and sliding along a surface of a contact target while maintaining direct contact with the surface; and
a cover member provided across the contact member from the contact target, wherein
the cover member comprises a connecting portion connected to the contact member and an exposed portion provided on top of the connecting portion, and
the exposed portion comprises a plurality of support members longitudinally disposed at intervals and a finishing member longitudinally connecting the tops of the support members, thereby forming an open-frame structure.

2. The wiper blade of claim 1, wherein the exposed portion has a tapering lateral cross-section that widens downwards.

3. The wiper blade of claim 1, wherein the exposed portion has a lateral flow path for a fluid to flow through between the support members longitudinally disposed at intervals.

4. The wiper blade of claim 3, wherein the support member comprises a plurality of first support members inclining in a first length direction from the bottom to the top, and the flow path is configured as a parallelogram.

5. The wiper blade of claim 4, wherein the support member further comprises a plurality of second support members inclining in a second length direction opposite the first length direction from the bottom to the top.

6. The wiper blade of claim 5, wherein the first support member and the second support member intersect at a predetermined point in the height direction.

7. The wiper blade of claim 5, wherein the second support member has a smaller width than the first support member.

8. The wiper blade of claim 1, wherein the contact member is concave towards the surface of the contact target when not in direct contact with the contact target and deforms to conform to the surface of the contact target when in direct contact with the contact target, while the cover member has an open-frame structure so that interference against the deformation of the contact member is reduced.

9. The wiper blade of claim 3, wherein the cover member is provided with the flow path relatively larger at the longitudinal center portion than at either end along its length.

10. The wiper blade of claim 3, wherein the flow path in the cover member gradually increases in size as the longitudinal center portion is approached from either end along its length.

11. The wiper blade of claim 3, wherein the plurality of support members incline in a first length direction from the bottom to the top to form a parallelogram-shaped flow path, and the exposed portion further comprises an interference member provided in the flow path to interfere with the fluid passing through the flow path.

12. A wiper blade comprising:
a contact member having a relatively high length-to-width ratio and sliding along a surface of a contact target while maintaining direct contact with the surface; and
a cover member provided across the contact member from the contact target, wherein
the cover member comprises a connecting portion connected to the contact member and an exposed portion provided on top of the connecting portion, and
the exposed portion has a lateral cross-section in a tapering form that widens downwards to impede fluid flow in the width direction on the contact target and generate a negative pressure on one side but has an open-frame structure at least along its width to guide the fluid flow from the other side to one side and increase the pressure on the one side.

13. A wiper device comprising the wiper blade of claim 1 and an adapter provided at one point on the wiper blade to be coupled to a wiper arm.

14. A wiper blade comprising:
a cover member having a relatively high length-to-width ratio and extending on one side relative to a reference point to form the length; and
a contact member sliding along the cover member to be attached or detached, wherein
the cover member comprises:
a connecting portion connected to the contact member;
an exposed portion provided on top of the connecting portion; and
a flow path opened in a direction orthogonal to the one side, wherein
the flow path is formed between a plurality of support members connecting the exposed member and the connecting member.

15. The wiper blade of claim 14, wherein the flow path is designed to be relatively larger as the reference point is approached.

16. The wiper blade of claim 15, wherein the flow path comprises a plurality of flow paths divided by an intersection point where the support members intersect to be formed in different sizes.

17. The wiper blade of claim 14, wherein the support member comprises a plurality of first support members inclining in a first length direction from the bottom to the top.

18. The wiper blade of claim 17, wherein the support member further comprises a plurality of second support members inclining in a second length direction opposite the first length direction from the bottom to the top.

19. The wiper blade of claim 18, wherein the flow path comprises an upper flow path formed above the intersection point where the first support member and the second support member intersect, or a lower flow path formed below the intersection point.

20. The wiper blade of claim 18, wherein the first support member connects the exposed portion and the connecting portion and is disposed on the same surface as the side surface of the cover member.
